(19) United States
(12) Patent Application Publication
(10) Pub. No.: US 2026/0366686 A1
(43) Pub. Date: Nov. 19, 2026

(54) LIGHT DEVICE COMPRISING A PLURALITY OF MODULES

(71) Applicant: VALEO VISION, Bobigny (FR)

(72) Inventors: Sylvain GIRAUD, Bobigny (FR); Nicolas MARTIN, Bobigny (FR)

(73) Assignee: VALEO VISION, Bobigny (FR)

(21) Appl. No.: 19/140,645

(22) PCT Filed: Dec. 20, 2023
(86) PCT No.: PCT/EP2023/086862

§ 371 Date: Jun. 18, 2025

(30) Foreign Application Priority Data
Dec. 21, 2022 (FR) FR2214077

(51) Int. Cl. F21S 41/32; B60Q 1/00; B60Q 1/04; F21S 41/148; F21S 41/151; F21S 41/25; F21S 41/36

(52) U.S. Cl. CPC F21S 41/321; B60Q 1/0041; B60Q 1/04; F21S 41/148; F21S 41/151; F21S 41/25; F21S 41/36

(57) ABSTRACT

The invention relates to a vehicle light device. The device includes a plurality of light modules that each include at least one light source, a collector provided with a reflective surface and a projection lens, the reflective surface being configured to reflect light rays from the light source toward the projection lens, and a support on which all of the light sources are arranged in a support plane. The support being inclined relative to a horizontal plane and the components of the modules having a particular relative arrangement that allows the rays reflected by the collector to be projected along the optical axis of the lens.

### TECHNICAL FIELD

The present invention relates to the field of lighting, this including signaling, and to the members, in particular optical members, that participate therein. It is applicable to the field of motor vehicles. In particular, it relates to a luminous de-vice incorporating a plurality of modules the light sources of which are located in a same carrier plane.

One potential end use is formation of a low beam with which the front of a motor vehicle is normally endowed. Such formation may be combined with production of other beams, in particular a complementary high beam.

### BACKGROUND OF THE INVENTION

In the automotive sector, devices capable of emitting light beams that perform or participate in the performance of lighting and/or signaling functions are known.

To meet regulations currently in force, these devices must emit light in desired locations while limiting light levels in certain zones.

These lighting devices or headlamps allow light beams to be produced. One example of a light beam is a low beam or dipped beam, i.e. a cutoff-containing beam mainly used at night for lighting purposes that has a range on the road of about 70 meters and the luminous distribution of which is such that the driver of an oncoming vehicle is not subjected to discomfort glare. Typically, this beam has a cutoff in its upper part, the cutoff having a horizontal segment, preferably about 0.57 degrees below the horizon, in order not to illuminate the zone in which the driver of an oncoming vehicle should be located, and an angled segment called the kink. The lighting device may also produce a high beam, or a complementary high beam making it possible to form, in combination with the low beam, a high beam.

It is known practice to produce these light beams using a plurality of luminous modules. One such luminous module conventionally comprises a collector with a reflective surface of revolution that has a shell-shaped profile in a half-space defined by a horizontal plane. A substantially point source of light, of the light-emitting diode type, is located at a first focal point on the reflective surface and shines into the half-space in the direction of said surface. The rays are thus reflected in a convergent manner toward a projecting lens. In this context, patent publication FR3118120 A1 discloses a luminous device comprising a plurality of luminous modules that are borne by a plate, providing a style effect (which may be required by the shape of the bodywork of the vehicle in the location of the headlamp in which the luminous device is installed) in which, when the vehicle is observed from in front, the beams emitted by the various modules from their projecting lenses form a profile that is tilted from a first end forming a low and advanced point (further in front of the vehicle) of the profile to a second end forming a high and retracted point (closer to the rear of the vehicle) of the pro-file. In order to achieve this, the various modules are borne by a common plate and the modules are juxtaposed along a profile in order to make the device ex-tend from near the front of the motor vehicle rearward. Furthermore, in order for the profile to extend from a low point to a high point, the plate is mounted in a tilted manner so as to make a non-zero angle relative to a horizontal straight line parallel to the optical axis. This arrangement causes all the modules to be tilted relative to the desired optical axis of projection (which is typically horizontal and directed toward in front of the vehicle) and entails a high complexity in the layout of the elements participating in the projection; in particular, in the embodiment shown in FIG. 5 of this prior-art document, the tilt of the plate, of the light sources and of the collectors requires prismatic projecting lenses to be employed, leading to losses and chromatic aberrations. Moreover, this technology is rapidly reaching limits as regards design of the prism of the lens, if it is de-sired for the profile formed by the modules to have a substantial tilt.

One object of the present invention is therefore to provide a device allowing the mentioned drawbacks to be overcome at least in part.

Other objects, features and advantages of the present invention will become apparent upon studying the following description and the accompanying drawings. It will be understood that other advantages may be incorporated.

### SUMMARY OF THE INVENTION

In order to achieve this objective, according to one embodiment, provision is made for a luminous device configured to project an output light beam along an optical axis of projection.

It is intended to be directed horizontally from the rear to the front of the vehicle in a functional position of the device in the vehicle, in which functional position the device equips one side of a front face of the vehicle with a view to projecting toward in front of the vehicle.

This device comprises:
a plurality of juxtaposed luminous modules each comprising at least one light source, one collector equipped with a reflective surface and one projecting lens, the reflective surface being configured to reflect, toward the projecting lens, light rays generated by the light source;
a carrier on which all of the light sources are arranged in a carrier plane, the carrier plane making an angle γ to a horizontal plane, about a tilt axis Y that is horizontal and perpendicular to the optical axis of projection, and making an angle φ to a horizontal plane, about the optical axis of projection.

This device is moreover such that:
the projecting lens of each luminous module has a lens optical axis parallel to the optical axis of projection, and
the reflective surface of each collector is configured so that the reflected light rays form a beam oriented in a main direction of reflection coincident with the lens optical axis, and
the light sources are arranged on the carrier with a first offset along the optical axis of projection, and with a second offset in a vertical direction Z, when the device is in the functional position,
at least one of the angles γ and φ is non-zero, the angle γ being contained in a first angular sector that allows the main direction of emission of the light sources to be directed toward in front of the vehicle in the functional position, and the angle φ is directed in a second angular sector that allows the main direction of emission of the light sources to be directed toward the interior of the vehicle in the functional position.

Thus, all the sources of the device may be arranged on a single carrier, typically a single plate possibly taking the form of a printed circuit board (though the de-vice may be integrated into a more complex system comprising other luminous modules on other carriers, in particular in order to produce light beams performing other vehicle lighting functions). Even though only one carrier is used, light reflected by the collector is nonetheless here directed along the optical axis of the projecting lens. This facilitates the beam projection phase.

Preferably, the lens is symmetric about the lens optical axis.

To direct the light from the reflector along the optical axis of the lens, the invention overcomes a prejudice that the collector and its light source must form an invariant assembly, i.e. their relative position is fixed and necessarily such that the tilt of the collector is the same as that of the source (which is determined by the tilt of the carrier). In contrast, the collector is here advantageously positioned independently of the position of the carrier, this allowing its main direction of re-flection to be directed along the optical axis of the projecting lens. This thus makes it possible to avoid using a prismatic lens as projecting lens.

Another aspect relates to a vehicle equipped with two luminous devices, the two devices each being located on one side of the vehicle and so as to project a light beam toward in front of the vehicle.

The two devices are preferably symmetric relative to a median vertical plane of the vehicle parallel to the optical axis.

### BRIEF DESCRIPTION OF DRAWINGS

Aims, objects, and the features and advantages of the invention will become more clearly apparent from the detailed description of one embodiment of the invention, which embodiment is illustrated by the following accompanying drawings, in which:

FIG. 1A is a partial representation of the front part of a motor vehicle, schematically showing a tilt parameter a desired for the profile of the luminous device.

FIG. 1B is a partial representation of the front part of a motor vehicle, schematically showing a tilt parameter β desired for the profile of the luminous device.

FIG. 2 shows a top view of the distribution of various modules to form a luminous device, in a first embodiment.

FIG. 3 shows a front view of the luminous device corresponding to the first embodiment.

FIG. 4 shows a profile view of the luminous device corresponding to the first embodiment.

FIG. 5 shows a perspective view of the luminous device corresponding to the first embodiment.

FIG. 6 shows elements of a luminous module participating in forming one part of the beam, and the path of some light rays, in the first embodiment.

FIG. 7 shows a chart giving one example of determination of a tilt angle of the carrier plane as a function of the parameters front tilt α and top tilt β.

FIG. 8 shows one example of a shape obtainable for a low beam, with various isocandela lines.

FIG. 9 shows a front view of a luminous device according to a second embodiment.

FIG. 10 shows a front view of a luminous device according to a third embodiment.

FIG. 11 schematically shows the tilt of a carrier plane in the second embodiment, relative to the vehicle.

FIG. 12 schematically shows the tilt of a carrier plane in the first embodiment, relative to the vehicle.

The drawings are provided by way of example and do not limit the invention. They are schematic conceptual depictions intended to facilitate understanding of the invention and are not necessarily drawn to the scale of practical applications.

### DETAILED DESCRIPTION OF THE INVENTION

Before starting a detailed review of embodiments of the invention, optional features that may possibly be used in combination or alternatively will be outlined below:
the first angular sector is between 0° and 12°;
the second angular sector is between 0° and 6°, and preferably between 0° and 3°;
for each luminous module 2, the projecting lens 23 is symmetric about its optical axis;
the light sources 21 are arranged on the carrier such that the first offset progresses monotonically along the optical axis of projection 5, and such that the second offset progresses monotonically in the vertical direction Z, when the device is in the functional position;
the light sources 21 form, in the carrier plane 4, a profile P that is directed to-ward the rear of the vehicle 0 when said profile P is directed toward the exterior of the vehicle 0, in the functional position;
the profile P forms a first projection in the vertical direction Z, in the plane formed by the optical axis of projection 5 and the tilt axis Y, which first projection has a first tilt β with respect to the tilt axis Y, the first tilt β being less than 50°, and preferably less than 35°;
the profile P forms a second projection along the optical axis of projection 5, in the plane formed by the vertical direction Z and the tilt axis Y, which second projection has a second tilt α with respect to the tilt axis Y, and wherein the second tilt α is less than 10° and preferably less than 5°;
for each luminous module 2, the reflective surface 221 comprises a rear edge 222 in the vicinity of which a focal point of the projecting lens 23 is located, preferably at a distance of less than 10 mm;
the device is configured to produce an output light beam of low-beam type.

With respect to the features set out below, terms relating to verticality, horizontality or transversality (or even the lateral direction), or equivalents thereof, are to be understood with respect to the position in which the module is intended to be fitted in a vehicle. The terms “vertical” and “horizontal” are used in the pre-sent description to denote, regarding the term “vertical”, a direction with an orientation perpendicular to the plane of the horizon (which corresponds to the height of the systems), and, regarding the term “horizontal”, a direction with an orientation parallel to the plane of the horizon. They are to be considered under the conditions of operation of the device in a vehicle. The use of these words does not mean that slight variations about the vertical and horizontal directions are excluded from the invention. For example, a tilt relative to these directions of the order of + or −10° is here considered to be a minor variation about the two preferred directions. With respect to the horizontal plane, the tilt is in principle between −5° and 4°, and it is between −6° and 7.5° laterally. Two directions are considered to be coincident or parallel if they do not have a notable angular off-set from the point of view of operation or in respect of manufacturing tolerances; in particular, an angular offset of less than or equal to 5° may be suitable. Furthermore, the adjectives “lower” and “upper” are to be considered in relation to the vertical direction; in a given context, an upper element will be located above (but not necessarily in contact or directly plumb with) a lower element, in the vertical direction.

In the illustrations, an orthogonal coordinate system XYZ is used as reference. The X-axis is horizontal and oriented from the front to the rear of the vehicle; the Y-axis is the horizontal axis transverse to the X-axis; and the Z-axis is vertical.

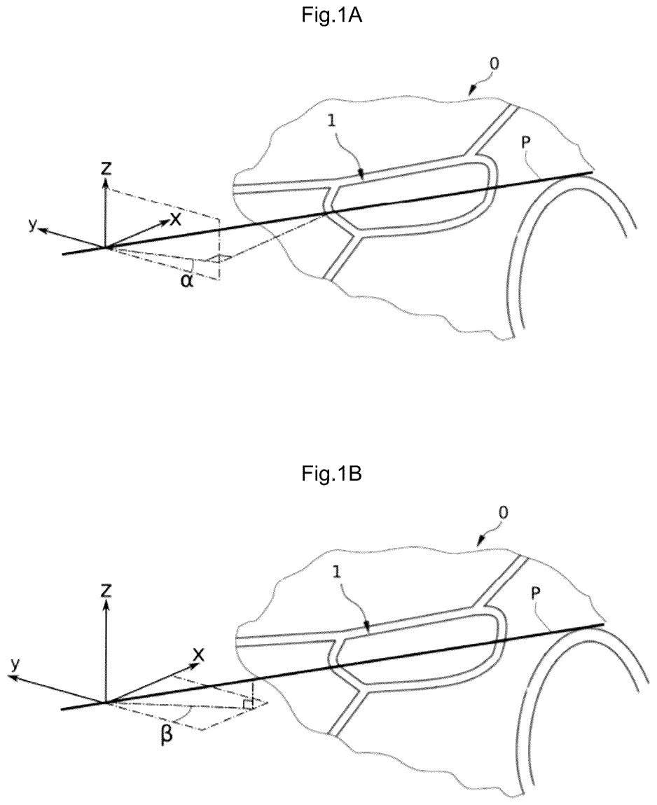

FIGS. 1A and 1B show, in perspective, a front segment of a vehicle 0, which front segment is provided with an optical unit 1 capable of receiving a lighting device according to the invention.

The X-axis corresponds to the longitudinal direction of the vehicle, the Y-axis to the width of the vehicle (in the present case horizontal and perpendicular to the longitudinal direction), and the Z-axis to a vertical direction (in which the height of the vehicle is measured). Typically, the optical axis of projection 5 of the beam resulting from the projection of the modules is directed along the X-axis, and oriented in the opposite direction, i.e. from the rear to the front of the vehicle.

As may be seen, the lighting device is placed at the front of the vehicle 0, on the left-hand side (in the direction of forward travel of the vehicle), it being under-stood that a symmetric lighting device is placed on the right-hand side of the vehicle. A profile P of arrangement of the modules of the lighting device has been shown; it is preferably rectilinear; in FIG. 1A, it may be seen that this pro-file P forms a second projection along the optical axis of projection 5, in the plane formed by the vertical direction Z and the tilt axis Y, which second projection has a second tilt α with respect to the tilt axis Y, and wherein the second tilt α is less than 10° and preferably less than 5°. The arrangement of the luminous modules 2 thus has a tilt α when seen from in front, this tilt in the present case being upward if a movement along the lighting device in the direction of the corresponding lateral flank of the vehicle 0 is considered.

Similarly, as may be seen in FIG. 1B, the profile P forms a first projection in the vertical direction Z, in the plane formed by the optical axis of projection 5 and the tilt axis Y, which first projection has a first tilt β with respect to the tilt axis Y, and wherein the first tilt β is less than 50°, and preferably less than 35°. The lighting device thus has a tilt β when seen from above, this tilt in the present case being directed toward the rear of the vehicle if a movement along the lighting device in the direction of the corresponding lateral flank of the vehicle 0 is considered.

The tilts or tilt by the angle α and/or the angle β may mainly be dictated by the shape of the bodywork of the vehicle, requiring a particular arrangement of the luminous modules that will be described below. The profile P may thus not necessarily be perfectly rectilinear; it may for example have a curvature, but it is desirable for the variation in the angles α and β to be monotonic, i.e. for their derivatives not to change sign.

FIG. 12 schematically shows the front part of a vehicle 0 and the general orientation of a plane 4 corresponding to the surface of the carrier that bears the light sources of the various modules illustrated below, in a first embodiment. In this particular case, it will be noted that the plane 4 is tilted with a normal exiting the vehicle with an angle γ between the X-axis and the carrier plane 4.

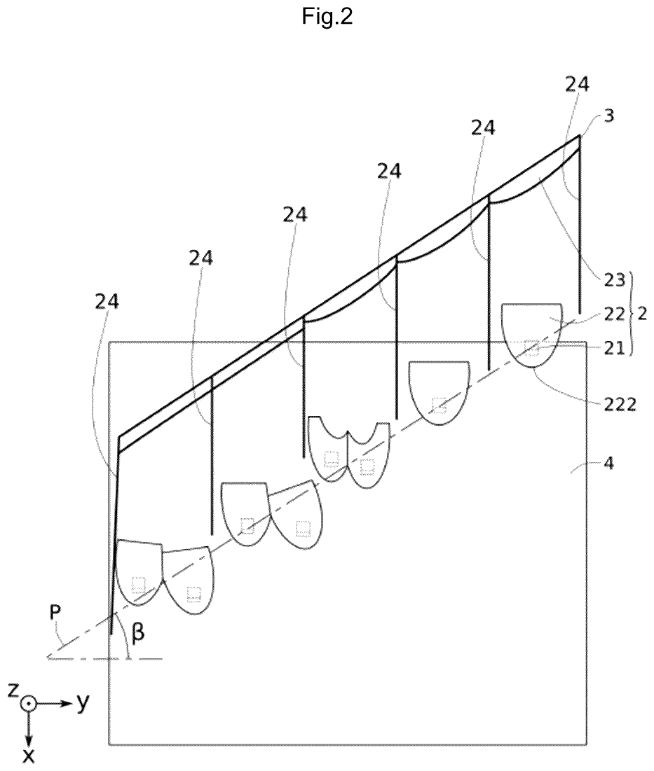

FIGS. 2 to 8 provide details of embodiment of the luminous device according to the invention in this first embodiment.

Thus, FIG. 2 provides a top view of a device comprising the plurality of modules 2. Each module 2 makes it possible to form a module beam and these various beams may be projected so as to produce the output beam of the luminous device. One or more modules 2 may be configured to produce a spread, basic beam of a form of low output beam; one or more other modules 2 may be configured to produce a cutoff-containing beam with a kink toward the center in or-der to complement the basic beam in a low output beam. For example, the modules 2 arranged in pairs in FIG. 2 may be used to form a flat of a low-beam headlight (i.e. a flat segment to be projected under the horizon); in a complementary manner, at least one of the other modules illustrated may form a kink forming the cutoff of this low beam; in this case, the profile of the rear edge 222 of the collector 22, which is described in detail below, is designed to give this cutoff its shape.

Optionally, one or more other modules 2 may be configured to form a complementary beam for a high-beam function, the complementary beam not containing a cutoff and causing emission of light above the horizon line.

According to one possibility, the modules 2 are selectively activatable so as to produce an adaptive output beam.

Each luminous module 2 comprises at least one light source 21. The latter may typically be a light-emitting diode. As shown in particular in FIG. 4, the light sources 21 preferably have an emission face 211 opposite a bottom face mounted on a carrier plane. Typically, all of the light sources 21 are borne by one carrier, such as a plate, which may be implemented with a printed circuit board.

The light sources 21 are spaced apart along the carrier, in such a way as to form the profile P indicated above. FIG. 2 provides one example of juxtaposition of modules 2, with a gradual offset (it is preferably monotonic, i.e. the offset is always in the same direction, and in particular toward the rear of the vehicle if a movement to the side of the vehicle is considered) of the position of the light sources 21 in the XY-plane. This progressive offset defines the profile P. The latter is advantageously rectilinear. According to one option, the light sources 21 are perfectly aligned along the profile P. However, for reasons of construction, there may be a certain offset between the position of a source 21 and the profile P. In this case, the profile P may be a straight line corresponding to the linear regression of the location of the sources 21. Alternatively, or in addition, the pro-file P may be defined as a median straight line that is not located at a distance of more than 3 mm from each of the light sources 21.

Each luminous module 2 further comprises a collector 22. The latter advantageously is the shape of a shell, the concave face of which has a reflective sur-face placed facing the source. The collector 22 has an edge face 223, the rear part of which, i.e. the part directed in the X-direction toward the rear of the vehicle, forms the rear edge 222 of the collector 22. The reflective surface 221 preferably has a parabolic profile set by a generatrix, with a focal point located at the light source 21 associated therewith. The focal length of the reflective sur-face 221 may be 3 mm. The distance between the rear edge 222 and the center of the exit face of the projecting lens 23 may be 65 mm.

It will be understood that the light emitted by a source 21 is addressed to the reflective surface of the collector 22 associated with the source 21 so as to pro-duce reflected rays in the form of a beam. Preferably, this reflected beam has a direction corresponding to that of the generatrix of the reflective surface.

Each module 2 further comprises a projecting lens 23. The various lenses 23 may be borne by a common carrier 3, as shown in FIG. 2. Preferably, the exit dioptric interfaces of the lenses 23 form a continuous surface. The lenses preferably each form a rectangular element. However, it is not indispensable for the active portion of the lens 23 to cover the entirety of the surface of this rectangular element; on the contrary, the active portion may be limited to a window, preferably a rectangular window, the arrangement of which is adjusted so as to form a projection axis oriented in the main direction of reflection of the corresponding collector. Certain modules 2 may comprise a plurality of collectors and preferably, for each collector, one associated light source, as is the case for three pairs of modules in FIG. 2. Moreover, the lenses may be integrally formed from a single piece of material.

The projecting lens 23 of each module 2 may be manufactured from an optical polymer; it may be a question of polymethyl methacrylate (PMMA) or polycarbonate. Preferably, the lenses are symmetric about the optical axis, at least in a plane corresponding to the height of the lens.

Furthermore, FIG. 2 illustrates separators 24 that extend between the collectors 22 and the lenses 23, in order to optically isolate at least certain of the modules.

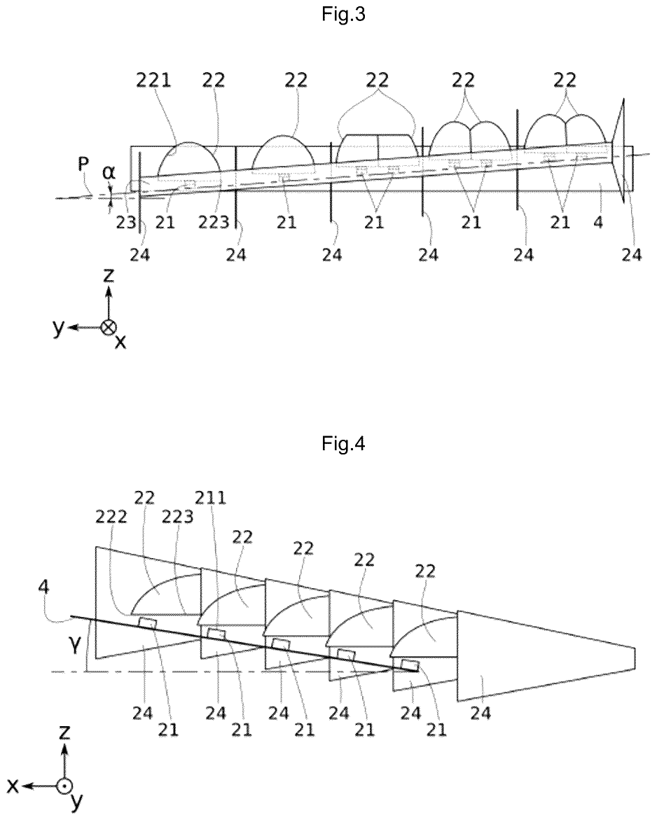

FIG. 3 provides another illustration of the first embodiment of the invention, this time as seen from in front. The angular offset a between the profile P and the direction of the Y-axis will be noted. Similarly to the case when viewed from above, it will also be noted here that the modules 2 are juxtaposed so that their offset progresses monotonically in the vertical direction. In particular, the closer the modules 2 are located to the side of the vehicle 0, the higher up they get.

Preferably, the lenses 23 follow the tilt of the profile P. In contrast, it is not necessary for the collectors 22 to have this tilt. In the first embodiment, preferably, the plane of symmetry of the collectors 22 is oriented along the normal to the emission face 211 of the corresponding source 21.

FIG. 4 shows another illustration of the first embodiment of the invention, in the XZ-plane. It will be noted that the carrier plane 4 makes an angle γ to the horizontal. In this way, it is possible to make the profile P progress over the carrier plane 4 in order to achieve the desired angles a and B. FIG. 4 moreover reveals that the generatrix of the profile of the collector 22 keeps a horizontal orientation, along the X-axis, despite the tilt of the carrier 4 by the angle γ. The edge face 223 of the collector 22 is horizontal.

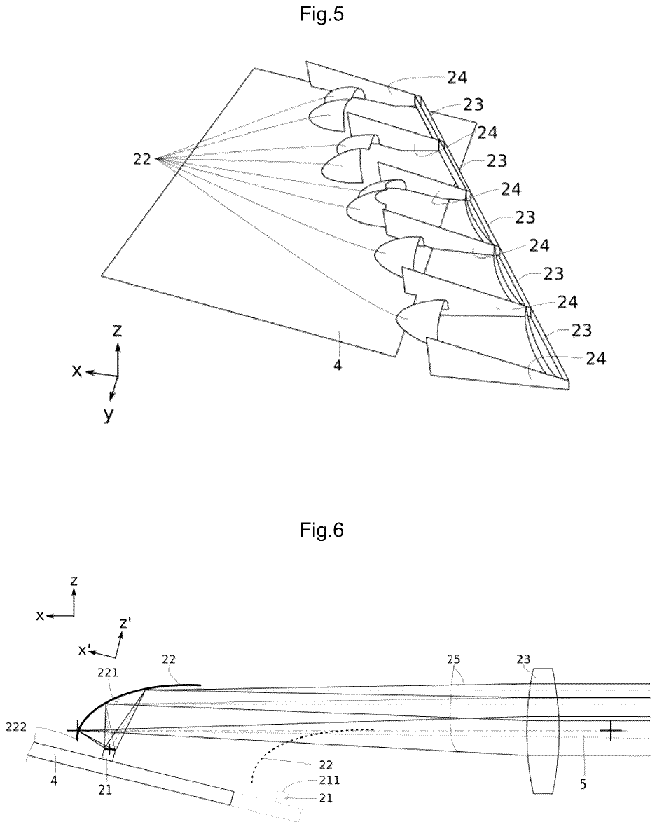

FIG. 5 is a perspective view revealing the resulting configuration of the luminous modules of the device, with the light sources borne on a carrier plane 4 that is itself tilted relative to the horizontal.

FIG. 6 provides one example of the path of light rays generated by a source 21 in this first embodiment, with a cross section in a plane oriented in XZ.

More particularly, the paths of various light rays are shown with reflection from the collector 22. The rays 25 issuing from the collector 22 are directed toward the projecting lens 23. Advantageously, the collector 22 is configured so that the main direction of reflection corresponds to the optical axis of the lens 23, which itself corresponds to the optical axis of projection 5 shown in FIG. 6. It may be seen that the tilt of the carrier plane 4, and therefore of the sources 21, is not followed by the collectors 22 the projection of which is on the whole directed along the optical axis of the lenses.

In this way, the output of the collector 22 is a beam that is correctly directed with respect to the projection objective of the output beam. In particular, this allows a non-prismatic lens to be used. Preferably, as shown in FIG. 6, it may be a question of a lens 23 that is at least symmetric about a horizontal plane comprising the optical axis 5.

To optimize this result and obtain a suitable direction for the beam reflected by the collector 22, it is advantageous to ensure that the first focal point of the lens 23 is located in the vicinity of the rear edge 222 of the collector 22. Preferably, the maximum distance separating the focal point of the lens 23 and the rear tip of the collector 22 is 10 mm.

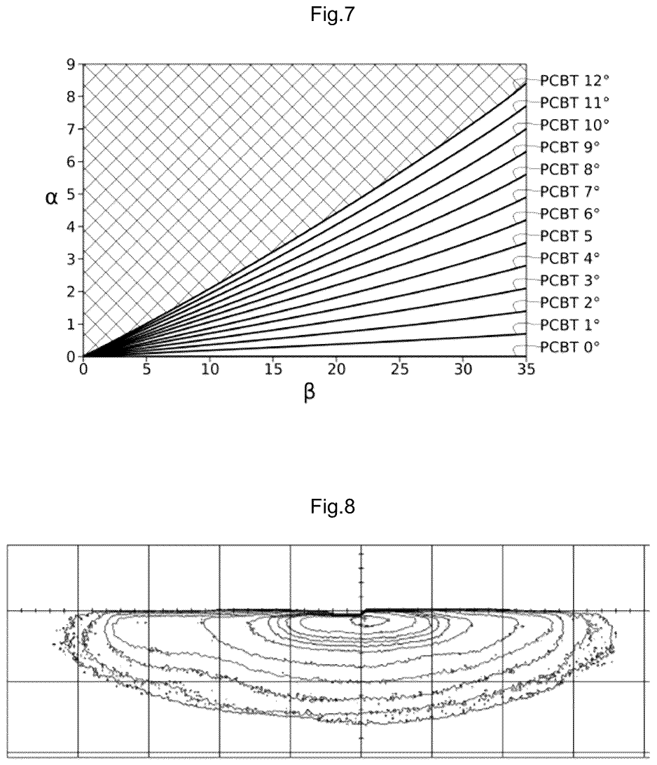

FIG. 7 is a chart showing, for the first embodiment, one example of determination of the tilt angle of the carrier plane 4 relative to a horizontal plane in the case of a rotation about the Y-axis, corresponding to the angle γ shown in FIG. 4 and indicated by the PCBT curves which plot, for a value of the angle γ, the angles β and α. Recourse to such a chart may be made, mutatis mutandis, in the two other embodiments described below.

The angles β and α are non-zero. Preferably, the angle β is chosen between 0° (limit excluded) and 50° (limit included); more preferably, it is less than or equal to 35°. Preferably, the angle α is chosen between 0° (limit excluded) and 10° (limit included); more preferably, it is less than or equal to 5°.

Generally, for the first embodiment and for the other embodiments described below, the angle γ is preferably between 0° (limit excluded if the angle φ dis-cussed below is zero, but included if the angle φ discussed below is non-zero) and 12° (limit included).

FIG. 8 provides one representative example of an isocandela curve of a projection produced by the luminous device thus proposed in order to form an out-put beam of low-beam type. The flat nature of the beam on the cutoff line may clearly be seen, there being a concentration of intensity in the vicinity of the optical axis.

In a second embodiment, the carrier plane 4 is tilted in such a way that it is turned about the X-axis, alternatively to the rotation about the Y-axis of the first embodiment.

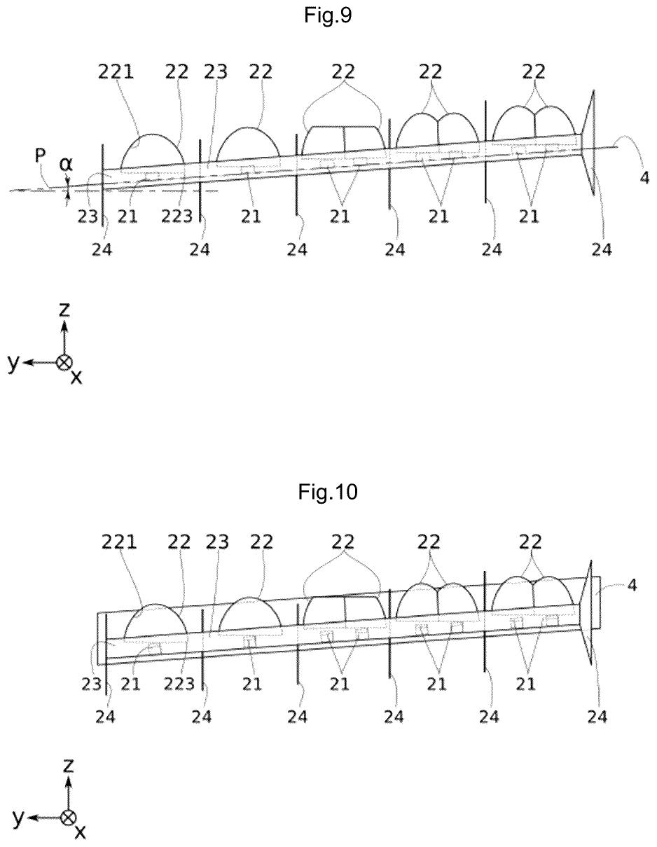

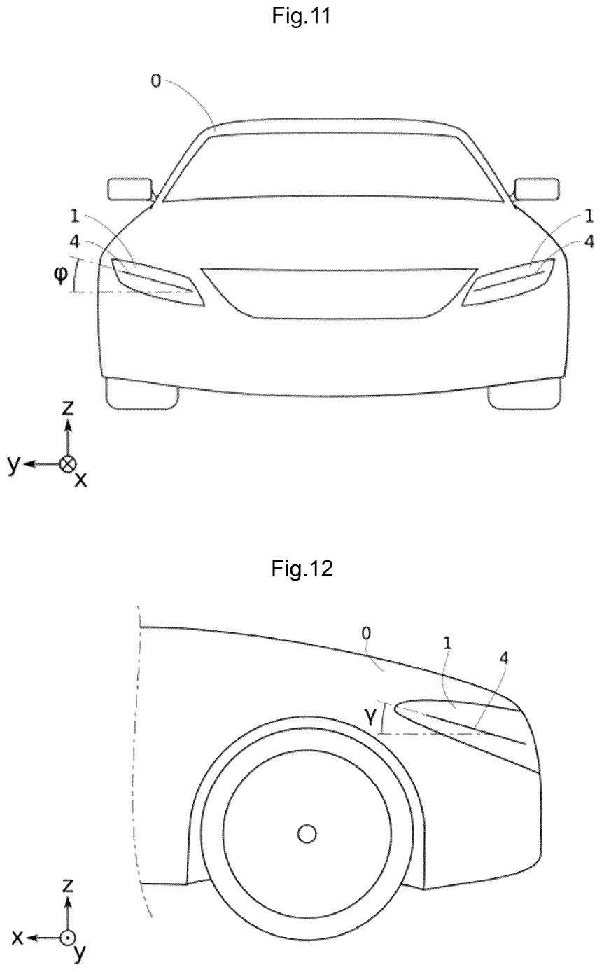

One example of a representation of a front view of this second embodiment is given in FIG. 9. As above, the modules 2, which each comprise at least one light source 21, one collector 22 and one projecting lens 23, are placed in a juxtaposed manner along a profile P in the plane 4. The indications given above in respect of details relating to the modules 22 and to their relative arrangement are entirely applicable to this second embodiment. The difference resides in the orientation of the plane 4. FIG. 11 schematically shows this difference, in comparison with the first embodiment shown in FIG. 12.

In FIG. 11, the carrier plane 4 is directed so as to make the angle φ to the Y-axis in the vertical YZ plane. It will be noted that this angle is configured so that the plane 4 rises gradually toward the side of the vehicle. As in the preceding embodiment, it is advantageous for the arrangements of the plane 4, and more preferably of the complete device, to be identical for two luminous devices each placed on a different side of the front face of the vehicle 0, typically in the optical units 1 shown in FIGS. 11 and 12.

Thus, in the second embodiment, comprising a tilt o, the carrier planes 4 of the two luminous devices with which the vehicle 0 is equipped form parts of strokes of a “V” the junction of which is located in a median plane of the vehicle directed along the XZ-plane.

Returning to FIG. 9, it will be noted that, as above, the light sources 21 are borne by the plane 4 and therefore have an emission face the normal of which is tilted relative to the Z-axis. In this situation the tilt φ directly determines the angle α, which is equal thereto. Preferably, the collectors 22 do not have this tilt and remain directed so that their generatrix is parallel to the X-axis; preferably, their edge faces 223 remain located in a plane parallel to the XY-plane. In this way, the beam reflected by the reflective surface of the collector 22 is projected with a satisfactory distribution of light around the optical axis 5 of the projecting lens 23. As above, it is advantageous for the rear edge 222 of the reflective sur-face 221 of the collector 22 to correspond substantially to one of the focal points of the projecting lens 23. The parameters regarding vicinity given above with reference to the first embodiment are applicable to the second embodiment.

Preferably, the angle φ is chosen between 0° (limit excluded if the angle γ is zero; limit included if the angle γ is non-zero) and 6° (limit included); more preferably, it is chosen to be less than or equal to 3°.

As suggested in the preceding paragraph, it should be apparent that the tilts y and o may be combined. FIG. 10 illustrates this embodiment with a plane 4 provided with this double tilt. The relative positions, of the elements of each module 2, indicated for the two preceding embodiments are applied in combination in this third embodiment. The indications given above in respect of the con-figurations suitable for the tilts (o and y, respectively) may therefore be implemented in association in this third embodiment.

In use, in every embodiment, one or more luminous modules 2 may be activated, preferably selectively, so as to each produce a module beam, the resultant of these module beams producing an overall output beam that is projected to-ward in front of the vehicle 0 in the direction of the optical axis 5. The planar tilts and the adaptations of relative position between the various components, in particular between the light sources, the collectors and the lenses, ensure, by virtue of the invention, projection of a uniform and optimized beam, in particular by decreasing aberrations, in the direction of the optical axis.

The invention is not limited to the embodiments described above.

What is claimed is:

1. A luminous device of a motor vehicle, the luminous device being configured to project an output light beam along an optical axis of projection intended to be directed horizontally from the rear to the front of the vehicle in a functional position of the device in the vehicle, in which functional position the device equips one side of a front face of the vehicle with a view to projecting toward in front of the vehicle, the luminous device comprising:
a plurality of juxtaposed luminous modules each including at least one light source, one collector equipped with a reflective surface and one projecting lens, the reflective surface being configured to reflect, toward the projecting lens, light rays generated by the light source, and
a carrier on which all of the light sources are arranged in a carrier plane, the carrier plane making an angle γ to a horizontal plane, about a tilt axis Y that is horizontal and perpendicular to the optical axis of projection, and making an angle φ to a horizontal plane, about the optical axis of projection;
the projecting lens of each luminous module has a lens optical axis parallel to the optical axis of projection, and
the reflective surface of each collector is configured so that the reflected light rays form a beam oriented in a main direction of reflection coincident with the lens optical axis, and
the light sources are arranged on the carrier with a first offset along the optical axis of projection, and with a second offset in a vertical direction Z, when the device is in the functional position, and
at least one of the angles γ and φ is non-zero, the angle γ being contained in a first angular sector that allows the main direction of emission of the light sources to be directed toward in front of the vehicle in the functional position, and the angle φ is directed in a second angular sector that allows the main direction of emission of the light sources to be directed toward the interior of the vehicle in the functional position.

2. The device as claimed in claim 1, wherein the first angular sector is between 0° and 12°.

3. The device as claimed in claim 1, wherein the second angular sector is between 0° and 6°.

4. The device as claimed in claim 1, wherein, for each luminous module, the projecting lens is symmetric about its optical axis.

5. The device as claimed in claim 1, wherein the light sources are arranged on the carrier such that the first offset progresses monotonically along the optical axis of projection, and such that the second offset progresses monotonically in the vertical direction Z, when the device is in the functional position.

6. The device as claimed in claim 5, wherein the light sources form, in the carrier plane, a rectilinear profile that is directed toward the rear of the vehicle when said profile is directed toward the exterior of vehicle, in the functional position.

7. The device as claimed in claim 6, wherein the profile forms a first projection in the vertical direction Z, in the plane formed by the optical axis of projection and the tilt axis Y, which first projection has a first tilt β with respect to the tilt axis Y, and wherein the first tilt β is less than 50°.

8. The device as claimed in claim 6, wherein the profile forms a second projection along the optical axis of projection, in the plane formed by the vertical direction Z and the tilt axis Y, which second projection has a second tilt α with respect to the tilt axis Y, and wherein the second tilt α is less than 10°.

9. The device as claimed in claim 1, wherein, for each luminous module, the reflective surface includes a rear edge in the vicinity of which a focal point of the projecting lens is located.

10. The device as claimed in claim 1, configured to produce an output light beam of low-beam type.

11. A vehicle comprising two devices, the two devices each being located on one side of the vehicle and so as to project a light beam toward in front of the vehicle, wherein each of the two devices include a plurality of juxtaposed luminous modules each including at least one light source, one collector equipped with a reflective surface and one projecting lens, the reflective surface being configured to reflect, toward the projecting lens, light rays generated by the light source, and a carrier on which all of the light sources are arranged in a carrier plane, the carrier plane making an angle γ to a horizontal plane, about a tilt axis Y that is horizontal and perpendicular to the optical axis of projection, and making an angle φ to a horizontal plane, about the optical axis of projection, the projecting lens of each luminous module has a lens optical axis parallel to the optical axis of projection, and the reflective surface of each collector is configured so that the reflected light rays form a beam oriented in a main direction of reflection coincident with the lens optical axis, and the light sources are arranged on the carrier with a first offset along the optical axis of projection, and with a second offset in a vertical direction Z, when the device is in the functional position, and at least one of the angles γ and φ is non-zero, the angle γ being contained in a first angular sector that allows the main direction of emission of the light sources to be directed toward in front of the vehicle in the functional position, and the angle φ is directed in a second angular sector that allows the main direction of emission of the light sources to be directed toward the interior of the vehicle in the functional position.

12. The vehicle as claimed in claim 11, wherein the two devices are symmetric relative to a median vertical plane of the vehicle parallel to the optical axis of projection.
